(19) United States
(12) Patent Application Publication
(10) Pub. No.: US 2013/0265169 A1
(43) Pub. Date: Oct. 10, 2013

(54) Eyewear Device Configured To Track Head Movement

(71) Applicant: Russell F. Mates, Clarks Summit, PA (US)

(72) Inventor: Russell F. Mates, Clarks Summit, PA (US)

(21) Appl. No.: 13/443,256

(22) Filed: Apr. 10, 2012

(51) Int. Cl. G08B 21/00; G02C 11/00

(52) U.S. Cl. 340/686.1; 351/158

(57) ABSTRACT

Disclosed is an eyewear device that includes eyeglass lenses and an eyewear frame configured to hold the eyeglass lenses. According to one example, the eyeglass frame may include a number of sensors configured to determine a position of the eyewear frame. The eyewear device may also include a transceiver configured to receive periodic radio frequency (RF) signals from a remote device and to transmit corresponding RF feedback signals to the remote device responsive to the received periodic RF signal and at least one operation indicator configured to initiate operation when the eyewear frame is moved outside of a predetermined position.

### RELATED APPLICATIONS

There are no previously filed, nor currently any co-pending applications, anywhere in the world.

### BACKGROUND OF THE INVENTION

1. Field of the Invention

The present invention relates generally to devices interfaced with tracking and monitoring devices and mechanisms, and more particularly, to an eyewear device configured to track head movement.

2. Description of the Related Art

Certain students have problems paying attention in a classroom environment. For example, a lack of experience, discipline and even neurological conditions may create problems for individuals sitting as students before a live teacher. Similarly, students with disorders such as attention deficit disorder (ADD) and other similar disorders may have an impairment that affects a student's ability to stay focused in front of a live teacher.

Currently there exist in the art various wearable devices interfaced with tracking and monitoring devices and mechanisms. However, the prior art has failed to disclose or teach an eyewear system comprising an eyewear frame configured to hold eyeglass lenses, the eyewear frame comprising a plurality of sensors configured to determine a position of the eyeglass frame, a transceiver configured to receive periodic radio frequency (RF) signals from a remote device and to transmit corresponding RF feedback signals to the remote device responsive to the received periodic RF signal, and at least one operation indicator configured to initiate operation when the eyeglass frame is moved outside of a predetermined position, as taught by the present application.

Accordingly, a need exists for an improved system configured for tracking head movement. The development of the eyewear system configured to track head movement fulfills this need.

A search of the prior art did not disclose any patents that read directly on the claims of the instant invention; however, the following references were considered related:

U.S. Pat. No. 7,648,236 B1, issued in the name of Dobson;

U.S. Patent Application no. 2011/0102149 A1, published in the name of Lin et al.;

U.S. Pat. No. 7,481,531 B2, issued in the name of Howell et al.;

U.S. Patent Application no. 2010/0308999 A1, published in the name of Chornenky;

U.S. Pat. No. 6,517,203 B1, issued in the name of Blum et al.;

U.S. Pat. No. 4,841,954, issued in the name of Kalsi; and

U.S. Pat. No. 7,760,898, issued in the name of Howell et al.

Consequently, a need has been felt for an improved system configured for tracking head movement.

This application presents claims and embodiments that fulfill a need or needs not yet satisfied by the products, inventions and methods previously or presently available. In particular, the claims and embodiments disclosed herein describe an eyewear apparatus comprising eyeglass lenses; and an eyeglass frame configured to hold the eyeglass lenses, the eyeglass frame comprising a plurality of sensors configured to determine a position of the eyeglass frame; a transceiver configured to receive periodic radio frequency (RF) signals from a remote device and to transmit corresponding RF feedback signals to the remote device responsive to the received periodic RF signal; and at least one operation indicator configured to initiate operation when the eyeglass frame is moved outside of a predetermined position, the eyewear apparatus providing unanticipated and nonobvious combination of features distinguished from the products, inventions and methods preexisting in the art. The applicant is unaware of any product, device, method, disclosure or reference that discloses the features of the claims and embodiments disclosed herein.

### SUMMARY OF THE INVENTION

Briefly described in accordance to an exemplary embodiment of the present invention, an eyewear apparatus is disclosed which includes eyeglass lenses and an eyewear frame configured to hold the eyeglass lenses. The eyeglass frame may include a plurality of sensors configured to determine a position of the eyewear frame. The eyeglass frame may also include a transceiver configured to receive periodic radio frequency (RF) signals from a remote device and to transmit corresponding RF feedback signals to the remote device responsive to the received periodic RF signal, and at least one operation indicator configured to initiate operation when the eyewear frame is moved outside of a predetermined position.

Another example embodiment may include an apparatus that includes a transceiver configured to transmit and receive wireless signals to and from an electronic eyewear device to determine whether a physical position of an eyewear frame of the eyewear device is in an acceptable position based on predetermined position criteria. The apparatus also includes a processor configured to initiate an alerting signal when the received wireless signals indicate that the eyewear frame is in an unacceptable position.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1A illustrates a front view of a pair of eyeglasses according to example embodiments;

FIG. 1B illustrates a detailed diagram of a pair of eyeglasses according to example embodiments; and

FIG. 2 illustrates a communication system including the eyeglasses and a corresponding instructor communication device according to example embodiments.

### DESCRIPTION OF THE PREFERRED EMBODIMENT

### Detailed Description of the Figures

It will be readily understood that the components of the present invention, as generally described and illustrated in the figures herein, may be arranged and designed in a wide variety of different configurations. Thus, the following detailed description of the embodiments of an apparatus and system, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

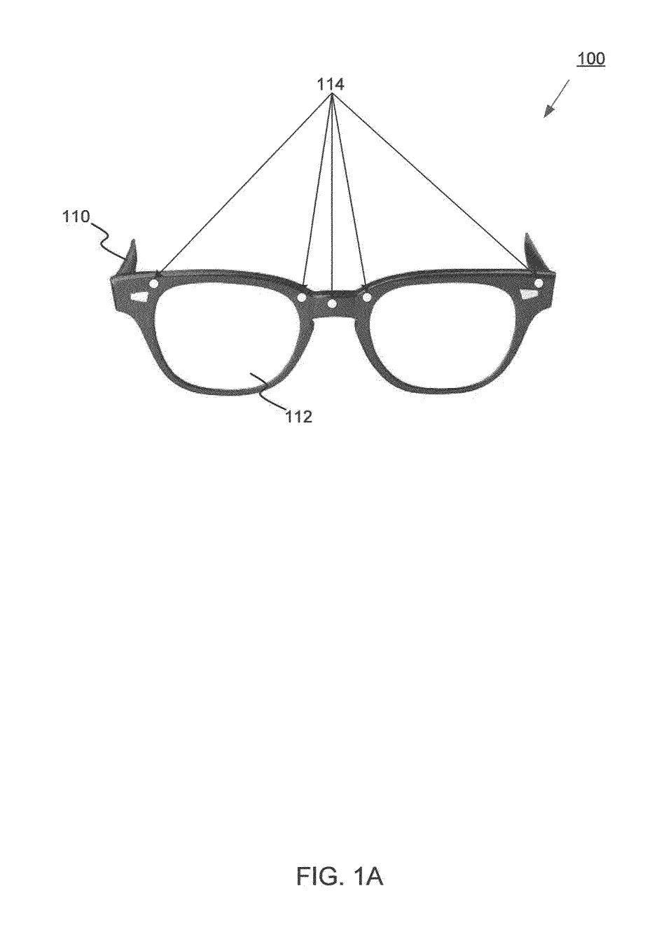

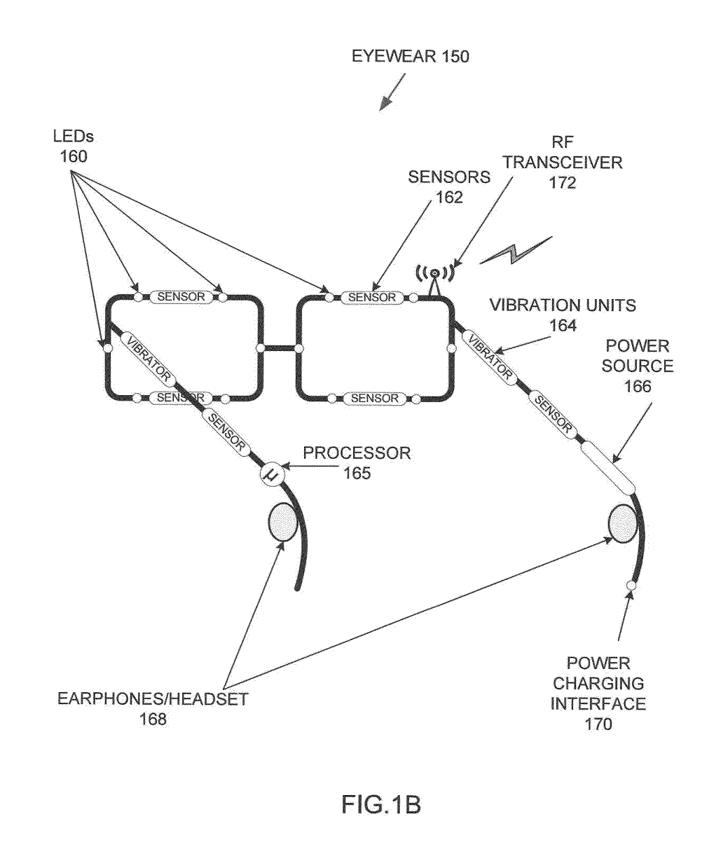

FIG. 1A illustrates a front view perspective of a pair of eyeglasses 100 according to an example embodiment. Referring to FIG. 1A, the eyeglass frame 100 may include any style of glasses that is operable to house internal sensors and other hardware necessary to realize the functionality of the example embodiments described in detail below. The eyeglass frames 110 may be configured to hold eyeglass lenses 112, which may be corrective lenses in the case of a visually impaired wearer, or non-corrective lenses in the case of a non-visually impaired wearer. One may appreciate that the invention may be realized with the eyeglass frame alone without utilizing any lenses.

From a front view perspective, the eyeglass frame may appear as a normal pair of glasses. Although, the light emitting diodes (LEDs) 114 may be viewable as being part of the front view of the eyeglass frame. However, the LEDs 114 may instead be part of the interior surface of the eyeglass frame. In the examples that follow, the eyeglass frame 114 will provide various functions and features that are not consistent with a normal pair of eyeglasses.

Referring to FIG. 1B, a detailed rear-view perspective of the eyeglasses is illustrated according to example embodiments. One example embodiment may provide eyeglasses or eyewear 150 that appears to be like a normal pair of eyeglasses and which is intended to be worn like a normal pair of eyeglasses. The individual person or “wearer” would place the glasses over his or her eyes and ears. The eyeglasses 150 may have various components, such as built-in sensors 162 which detect when the wearer looks away from a presenter/teacher/instructor by sensing a change in head direction with respect to a central location.

As a result of the wearer's head movement, a device located at a central location may transmit indication signals to the eyewear. For example, the indication signals may trigger the illumination of one or more LED lights outside and/or inside the frame of the eyeglasses. The LEDs 160 may remind the wearer or the instructor that the head position has been turned away indicating a lack of attention being maintained by the observer/student/pupil. Also, the eyeglasses 150 may include one or more vibration devices 164 (i.e., vibrotactile stimulator) which cause the eyewear to vibrate. Other indicators may include audio signals from earphones 168 attached to the eyewear, which prompt the wearer to refocus his intention on the presenter.

The eyewear frame 150 may include an array of LED's 160 disposed spatially about the frame. The number of LEDs may include 2, 4, 6, 8, 10 or even more LEDs. The LEDs may be disposed in the interior surface of the eyeglass frame 150 and/or on the external surface of the eyeglass frame. There may be a plurality of sensors 162 configured to sense the wearer's head position and/or configured to receive a radio frequency (RF) signal from a remote location. For example, six sensors 162, one on each side of the glasses and one located above and below each lens, may be used to sense a remote RF signal and provide a feedback communication signal via a RF antenna/transceiver 172.

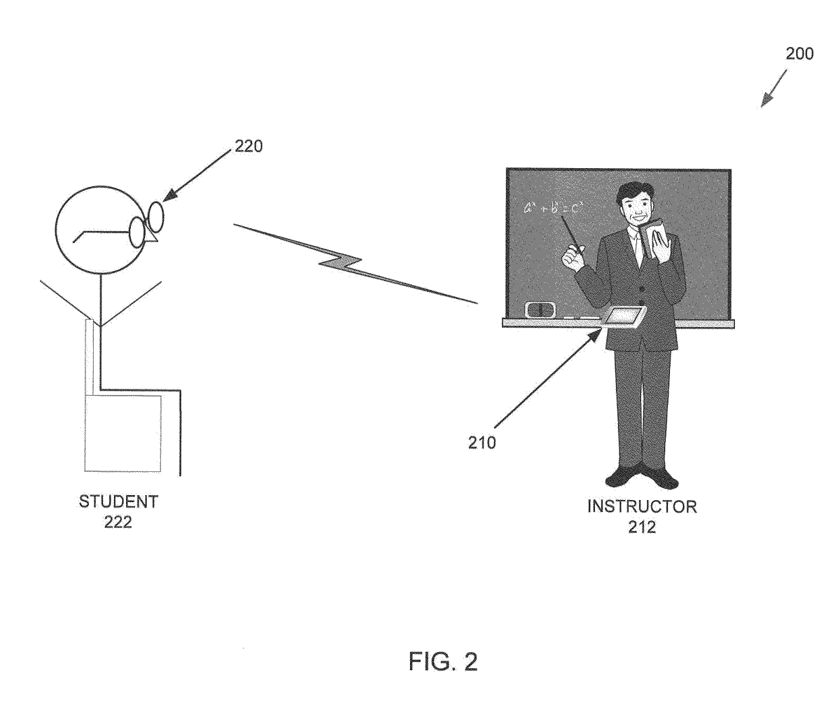

Vibration units (vibrotactile stimulators) 164 may be disposed on each side of the eyewear frame 150 permitting either side or both sides of the eyeglass frame to vibrate against the wearer's face or head. A power source 166, which may be any of a variety of rechargeable or non-rechargeable batteries, may be part of the eyewear frame 150 and wired to each of the various components to provide electrical power. An earphone headset 168 may include any variety of earphones that are designed to fit over the ears or be fitted inside the ears, and may also be physically connected to the eyeglasses or may be wirelessly adapted to communicate with the eyewear frame. A power charging interface 170 may be part of the eyewear frame and may connect the eyeglasses to external power to charge the power source 166. The sensors 162 may be coupled to the transceiver antenna 172, which sends and receive signals from an external unit 210 described in detail with respect to FIG. 2.

FIG. 2 illustrates a communication system including the eyeglasses and a corresponding instructor communication device according to example embodiments. Referring to FIG. 2, the communication system 200 provides two devices in communication with each other. For instance, the instructor's external device or controller device 210 may be in communication with the eyewear 220 worn by an observer or student in a classroom environment. The eyewear 220 communicates with the external device 210 worn by an instructor 212. The eyewear 220 tracks a head position of the wearer or student 222 and determines the head position of the wearer by transmitting periodic RF signals to the external device 210 and by receiving RF signals back from the external device 210. The instructor's external device 210 may be placed in front of a teaching area (blackboard, podium, etc.) or worn by the instructor, provided that the device is not moved substantially when the eyewear of the various students is in the process of being tracked for movement.

Example operations used to determine a head position of the wearer(s) via an exchanging of signals can include but are not limited to RF triangulation, which may be used to determine differences in the times of received signals via two or more locations as measured at a particular point. Triangulation may also use differences in signal power to determine information regarding location and direction. As a result, a power level difference in the signals received from the various sensors of the eyewear 220 may indicate a change in head position as compared to previously measured values or predetermined stored values stored in memory at the remote device. The remote device 210 may be a computer, laptop, mobile, wireless or cellular phone, a PDA, a tablet, a client server or any device that contains a processor and memory.

According to another example, a discontinuation of the receiving of signals for a period of time may trigger an action taken by the eyewear device 220. For example, the action may include initiating one or more of the vibration units on the frame of the eyewear as a warning to remind the wearer to look straight ahead and adjust his or her head position. Once an action is taken, a timer may wait a certain amount of time before activating the vibration units. Then, after another longer period of time has elapsed and the wearer's head is still in a sideways or off-centered position, the LEDs may trigger and begin illuminating to remind the student and the teacher that the student is not focused on the instructor.

According to another example embodiment, an Infrared (IR) signal may be used to keep the eyewear from activating by transmitting continuous IR signals to a sensor on the eyewear via a line of sight communication path. If the wearer looks away then the IR signal may not be received and after a certain period of time one or more of the indicators may activate to remind the student to face the correct direction.

The wireless signals may be sent from the eyeglass frame to the external device indicating the wearers' head position on a time measured basis. For example, once every millisecond, 10 milliseconds, etc., or periodically per any other unit of time, the communication signaling may be required to indicate the head position of the wearer of the eyeglass frame 150 to avoid any activation of the indicators. The sensors may send and receive wireless signals using a variety of technologies including but not limited to Bluetooth®, wireless Ethernet 802.11, FM or AM signals, infrared, or any other wireless technology.

If the external device 210 determines that the head position of the wearer is outside an acceptable range for more than a predetermined period of time, then the external device 210 may transmit instructions to the eyeglass frame 220 to initiate one or more of the indicators (i.e., vibration units, LEDs, audible indicators). In turn, the indicators will prompt the wearer to change his or her head position so that he/she is again facing the instructor. When the head position of the wearer is returned to an acceptable range, the indicators will cease.

The indicators may include vibration units which vibrate, audible indicators which initiate an audible signal and/or LEDs which illuminate. The LEDS may be operated by illuminating one at a time, or more than one LED may be illuminated depending on the mode of operation. The LED lights may be directed toward the eyes of the wearer and/or externally towards the instructor. The earphones may be used as another indicator by creating audible alerts via the earphones/headset 168 as triggered by head position. The indicator(s) may initiate and take a first action, such as vibrating the frames if the wearer has an unacceptable head position for more than a first specified period of time (i.e., 5 seconds). If the wearer does not correct his/her head position after a second specified period of time (i.e., 10 seconds) that is longer than the first specified period of time, the alert may increase in magnitude (i.e., brighter, louder, harder) by offering a larger voltage from the power source on the eyewear frames as controlled by a controller/processor 165 embedded in the eyewear frame. Additional alerts may occur, for example, some of the LEDs may illuminate and the vibrations may increase in magnitude if the wearer does not correct his/her head position after a third specified period of time (20 seconds), the alerts may increase in magnitude and/or additional alerts may occur, such as all of the LEDs may illuminate, vibrations may increase again more frequently, and an audible signal may occur louder or more frequently. It may be appreciated that the alerts may continue to take on new forms and increase if the wearers head position is not acceptable after a 4th, 5th, 6th . . . nth period of time.

A further example embodiment of the present invention includes the ability for the instructor to “manually override” or initiate the alerts by selecting a control on the remote device 210. In certain circumstances, the wearer may be in an acceptable position but may be drifting off to sleep. In this example, the instructor 212 may use the device to send an audible indication to the student to awake and prompt him or her to pay attention. The remote device may include a transceiver, memory, a processor, a display and any other component commonly associated with a computing device. The remote device may be capable of determining the status of the eyewear frame, its present position and whether an operation indicator prompt should be initiated to inform the wearer that their present head position should be changed.

It is envisioned that the various embodiments, as separately disclosed, are interchangeable in various aspects, so that elements of one embodiment may be incorporated into one or more of the other embodiments, and that specific positioning of individual elements may necessitate other arrangements not specifically disclosed to accommodate performance requirements or spatial considerations.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Therefore, it is to be further understood that the embodiments described are illustrative only and the scope of the invention is to be defined solely by the appended claims when considered with a full range of equivalents, and modifications (e.g., protocols, hardware devices, software platforms etc.) thereto. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. An eyewear apparatus comprising:
eyeglass lenses; and
an eyewear frame configured to hold the eyeglass lenses, the eyewear frame comprising:
a plurality of sensors configured to determine a position of the eyewear frame;
a transceiver configured to receive periodic radio frequency (RF) signals from a remote device and to transmit corresponding RF feedback signals to the remote device responsive to the received periodic RF signal; and
at least one operation indicator configured to initiate operation when the eyewear frame is moved outside of a predetermined position.

2. The eyewear apparatus of claim 1, wherein the at least one operation indicator comprises a first operation indicator and a second operation indicator which are each configured to initiate operation at different time intervals.

3. The eyewear apparatus of claim 2, wherein the first operation indicator is a vibrotactile stimulator configured to vibrate a selected portion of the eyewear frame at a first time interval and the second operation indicator is a light emitting diode (LED) indicator configured to illuminate on the eyewear frame at a second time interval later than the first time interval.

4. The eyewear apparatus of claim 3, wherein the LED indicator comprises at least one LED in an array of LEDs disposed spatially about the eyewear frame.

5. The eyewear apparatus of claim 1, wherein the RF feedback signals are transmitted outside of at least one of a predetermined power level and a predetermined time frame responsive to the eyewear frame being moved outside of the predetermined position.

6. The eyewear apparatus of claim 1, further comprising:
a power source disposed on the eyewear frame configured to provide power to the plurality of sensors and the transceiver.

7. The eyewear apparatus of claim 1, further comprising:
at least one earphone speaker disposed on the eyewear frame configured to provide an audible signal responsive to the eyewear frame being moved outside of the predetermined position.

8. The eyewear apparatus of claim 1, further comprising:
a processor configured to initiate operation of the at least one operation indicator responsive to the eyewear frame being moved outside of the predetermined position for a predetermined period of time.

9. The eyewear apparatus of claim 1, wherein the predetermined period of time is at least one of 5 seconds, 10 seconds and 20 seconds.

10. An apparatus comprising:
a transceiver configured to transmit and receive wireless signals to and from an electronic eyewear device to determine whether a physical position of an eyewear frame of the eyewear device is in an acceptable position based on predetermined position criteria; and
a processor configured to initiate an alerting signal when the received wireless signals indicate that the eyewear frame is in an unacceptable position.

11. The apparatus of claim 10, wherein the alerting signal is transmitted via the transceiver to the eyewear apparatus to initiate at least one operation indicator on the eyewear device if the eyewear frame is found to be in an unacceptable position for more than a predetermined period of time.

12. The apparatus of claim 11, wherein the at least one operation indicator comprises a first operation indicator and a second operation indicator which are each configured to initiate operation at different time intervals.

13. The apparatus of claim 12, wherein the first operation indicator is a vibrotactile stimulator configured to vibrate a selected portion of the eyewear frame at a first time interval and the second operation indicator is a light emitting diode (LED) indicator configured to illuminate on the eyewear frame at a second time interval later than the first time interval.

14. The apparatus of claim 13, wherein the LED indicator comprises at least one LED in an array of LEDs disposed spatially about the eyewear frame.

15. The apparatus of claim 10, wherein the wireless signals received are outside of at least one of a predetermined time frame and a predetermined power level responsive to the eyewear frame being moved outside of the predetermined position.

16. The apparatus of claim 10, wherein the wireless signals are radio frequency (RF) signals.

17. The apparatus of claim 10, wherein the wireless signals are infrared (IR) signals.
